(19) United States
(12) Patent Application Publication
(10) Pub. No.: US 2015/0059908 A1
(43) Pub. Date: Mar. 5, 2015

(54) Plastic Hose with Fabric Reinforcement

(71) Applicant: NORRES Beteiligungs-GmbH, Gelsenkirchen (DE)

(72) Inventor: Burkhard Mollen, Essen (DE)

(21) Appl. No.: 14/471,162

(22) Filed: Aug. 28, 2014

(30) Foreign Application Priority Data
Aug. 29, 2013 (DE) 10 2013 109 362.0

(51) Int. Cl. F16L 11/08

(52) U.S. Cl. CPC F16L 11/083
USPC 138/132; 138/137

(57) ABSTRACT

Represented and described is a plastic hose, comprising: a hose wall of plastic, and a fabric reinforcement. In order to ensure that the cross-sectional shape or area of the hose, and in particular the thickness of the hose wall, can be varied in a simple manner, it is proposed that the hose wall be manufactured from one or a plurality of spirally-wound plastic strips.

### CROSS-REFERENCE TO RELATED APPLICATION

This application claims priority to German Patent Application No. 10 2013 109 362.0 filed Aug. 29, 2013, the disclosure of which is hereby incorporated in its entirety by reference.

### BACKGROUND OF THE INVENTION

1. Field of the Invention

The invention concerns a plastic hose, comprising: a hose wall of plastic, and fabric reinforcement.

2. Description of Related Art

In the field of hose technology numerous different types of tubes or hoses are of known art. By virtue of its advantageous material properties plastic is often deployed in the manufacture of hoses. Such hoses are designated as plastic hoses or all-plastic hoses. Some of these hoses of known art are reinforced by means of threads, yarns or fabrics. Here these often take the form of hoses with a plurality of extruded layers, between which the reinforcement is arranged.

From DE 24 29 680 A1, for example, a high pressure hose is of known art. The hose comprises an extruded inner hose, which by means of a wrapping device is wound around with an armouring of nylon fibre strands running in a crosswise manner. An extruded outer sleeve is then pulled over the inner hose and the armouring, so that the armouring is arranged between the inner hose and the outer sleeve. The armouring is bonded by means of adhesives with the inner hose and the outer sleeve.

As a result of the armouring the stiffness of the hose in the radial direction can be increased. This has the advantage that in the case of a high internal pressure the hose does not expand excessively. Furthermore a high radial stiffness serves to provide a constant cross-sectional area and prevents any kinking of the hose. However, what is disadvantageous regarding the hose shown in DE 24 29 680 A1 is that the stiffness in the axial direction, that is to say in the longitudinal direction of the hose, can only be increased slightly.

This is due to the fact that the nylon fibre strands of the armouring run at an angle relative to the longitudinal direction of the hose. Moreover extruded hoses have the disadvantage that the cross-sectional shape and area cannot be varied along the length of the hose, so that no hoses can be manufactured that—as a result of armouring, for example—have a corrugated surface.

A hose with improved reinforcement is, for example, of known art from DE 43 24 973 A1. The essential difference from the hose described above lies in the fact that in addition to the two reinforcement threads running in a crosswise manner reinforcement threads are also provided that run approximately axially. These additional reinforcement threads are designed to be introduced in a symmetrical waveform running parallel to the longitudinal axis.

As a result of the approximately axially running reinforcement threads the stiffness of the hose in the axial direction is increased. This has the advantage that the hose can also withstand higher tensile loads without excessive elongation. However, what is also disadvantageous in the hose of known art from DE 43 24 973 A1 is the lack, as a matter of principle, of any possibility of using the extrusion method to vary the cross-sectional shape or area of the hose.

### SUMMARY OF THE INVENTION

The object underlying the invention is therefore that of configuring and developing a plastic hose, as cited in the introduction and described above in more detail, such that the cross-sectional shape or area of the hose, and in particular the thickness of the hose wall, can be varied in a simple manner.

This object is achieved by means of a plastic hose in accordance with the preamble of claim 1, in that the hose wall is manufactured from one or a plurality of spirally-wound plastic strips.

Plastic hoses in accordance with the invention have a hose wall and fabric reinforcement. The hose wall is manufactured from a plastic, in particular from a thermoplastic plastic. In particular the materials TPU (thermoplastic polyurethane), PVC (polyvinyl chloride), TPE (thermoplastic elastomers), or PE (polyethylene) have proven their worth. The deployment of plastics is distinguished by variable shaping, high flexibility, low weight and low costs. Fabric reinforcement is understood to mean reinforcement by a plurality of threads or yarns that are in contact with one another. These threads can, for example, be loosely laid one upon another, or can also be woven or interlaced with one another. The fabric reinforcement serves the objective of increasing the stiffness of the hose wall, so that even in the event of high internal pressures the hose does not experience excessive expansion. In particular, polyamides and polyester yarns have proven their worth as materials for the yarn reinforcement.

For some applications it is desirable or necessary for the thickness of the hose wall not to remain constant in its implementation, but rather to vary. For example, it can be desirable to provide spirally-winding armouring in the hose wall. However, in order to save material and weight, the hose wall should only have a greater thickness on the outer surface in the region of the armouring; in contrast the inner surface should remain as smooth as possible so as not to increase flow resistance. A further reason for varying wall thicknesses can lie in the combination of desired properties such as higher flexibility and compressibility (thin wall sections) and higher stiffness (thick wall sections).

By virtue of the fact that in accordance with the invention the hose wall is manufactured from one or a plurality of spirally-wound plastic strips, the desired variation of the thickness of the hose wall can easily be achieved. In particular, the thickness of the hose wall can be varied by means of the cross-sectional shape of the plastic strips. The concept underlying the invention is therefore not to extrude a fabric-reinforced hose as such, but in the first instance to extrude a plastic strip and to reinforce the latter with a fabric. In addition armouring of plastic or metal can be integrated into the plastic strips during the actual extrusion process. A hose is then formed from the fabric-reinforced and, on occasion, armoured plastic strip by means of a process of spiral winding and welding or adhesive bonding. With this procedure hoses with a more complex structure can be manufactured than is possible using the extrusion method. The hose wall is preferably manufactured from one or a plurality of spirally-wound plastic strips, and in particular has no other—non-wound-layers or coatings. By virtue of the spiral winding of plastic strips such a hose is also designated as a “wound hose”; a method for its manufacture is, for example, described in DE 198 48 172 A1.

One configuration of the invention provides for the fabric reinforcement to be integrated into the hose wall. The integration of the fabric reinforcement into the hose wall has the advantage that the fabric reinforcement is particularly securely bonded with the hose and cannot separate from the latter. Furthermore, an integrated fabric reinforcement is particularly well protected from environmental influences and wear by the surrounding hose wall.

In a further design of the invention provision is made for an inner layer that extends over the whole of the inner surface of the hose. The inner layer is also designated as an “inliner” and is in direct contact with the material that is conveyed through the hose. As a result of the friction of the conveyed material on the inner surface of the inner layer particular requirements are placed on the inner layer of the hose. The inner layer can therefore be manufactured from a particularly wear-resistant material. Furthermore, the inner layer is responsible for the sealing of the hose, so that in particular materials that are impervious to gases and liquids can be deployed for this layer. Provision is made for the inner layer to extend over the whole of the inner surface of the hose. In other words the inner layer is to cover the whole of the inner surface of the hose. This has the advantage that the whole of the surface coming into contact with the conveyed material has the same—desired—properties. In particular, the inner layer can be manufactured from TPU (thermoplastic polyurethane), PVC (polyvinyl chloride), TPE (thermoplastic elastomers), or PE (polyethylene). To ensure good flow conditions the inner surface of the inner layer should preferably be designed to be smooth.

With reference to the inner layer, it is further proposed that the inner layer be manufactured from one or a plurality of spirally-wound plastic strips. As a result of the spiral structure of the inner layer the same advantages ensue as have already been described for the—similarly spirally structured—hose wall. Also the manufacture of the inner layer can take place in the same way as the manufacture of the hose wall, in particular, that is to say, by the winding and welding or adhesive bonding of the plastic strips. To ensure good flow conditions in the case of an inner layer that is manufactured by the winding of plastic strips the aim is again to achieve a smooth design for the inner surface of the inner layer.

In accordance with a further teaching of the invention it is proposed that the plastic strips forming the hose wall and/or the inner layer are to have edge regions arranged in an overlapping manner; in the region of the overlap these edge regions are to be materially bonded with one another. The material bonding can in particular be generated by adhesive bonding and/or welding methods. With a materially-bonded joint a particularly reliable sealing of the seam is achieved.

In accordance with a further design of the invention it is proposed that the thickness of the inner layer be less than the thickness of the hose wall. In particular, provision can be made for the inner layer to have a thickness of 1 mm or less, in particular 0.5 mm or less. A particularly thin inner layer saves on costs, since very high quality plastics are regularly deployed for the particularly highly loaded inner layer; these are more expensive than the conventional plastics that are, for example, deployed for the hose wall. Moreover, as a result of thin inner layers the mechanical properties of the hose, which are primarily determined by the hose wall and the armouring, are modified or impaired as little as possible.

In accordance with a further configuration of the invention it is proposed that the fabric reinforcement be arranged between the hose wall and the inner layer. By means of this arrangement a simplification is achieved in manufacture, since the fabric reinforcement does not need to be integrated into either the hose wall or the inner layer.

An improvement of the mechanical properties of the hose can be achieved in a further form of the invention by means of an armouring of plastic or metal, wherein the armouring has a higher stiffness than the hose wall and/or the inner layer. Armouring is understood to take the form of a reinforcement of the hose that increases its stiffness—that is to say its resistance to deformation. The increased stiffness compared with that of the hose wall can be achieved by manufacturing the armouring from a plastic other than that of the hose wall, or from a metal. Alternatively the hose wall and the armouring can also be manufactured from the same plastic, but can contain different additives in order to achieve different mechanical properties. Armouring in the form of metal, in particular in the form of steel, has the advantage of a particularly high stiffness; moreover it can conduct away electrical charges and thus can even out electrical charge concentrations. The armouring can, for example, be designed in a spiral form or ring form, and thus can be guided around the hose. In particular the armouring can run in a spiral form or ring form about a central axis running along the longitudinal direction of the hose. Armouring that runs in the form of a spiral or ring has the advantage that the stiffness of the hose increases in the radial direction such that the—preferably round—cross-sectional shape of the hose remains intact in the armoured region. At the same time the bending stiffness is increased only insignificantly, or not at all, by armouring running in the form of a spiral or ring, so that a hose with this type of armouring can continue to be bent and laid in the form of a curve. A further advantage of armouring in the form of a spiral or ring is that the hose can be compressed in the longitudinal direction. The thickness, i.e. the diameter, of the armouring can lie in the range between 0.5 mm and 5 mm.

With regard to the arrangement of the armouring it is proposed in accordance with a development of the invention that the armouring be arranged between the overlapping edge regions of the plastic strip. In particular, this can be the plastic strip that forms the hose wall. With this arrangement the armouring is protected from environmental influences, as a result of which, for example, the risk of corrosion is reduced. In particular, the armouring can be arranged in a cavity that is formed between the overlapping edge regions of the plastic strip. The cavity enables a defined arrangement, i.e. positioning, of the armouring. Furthermore by means of the arrangement in the cavity the armouring is particularly well protected from environmental influences. The cavity can be achieved, for example, by means of two welded or adhesively bonded seams running parallel to, and spaced apart from, one another.

Alternatively it is proposed that the armouring be integrated into the plastic strip. In particular this can also be the plastic strip that forms the hose wall. An integration of the armouring can be achieved by introducing the armouring into the strips during the actual extrusion of the plastic strip. This has the advantage that the armouring no longer has to be supplied during the welding of the plastic strip, but rather is already located in the plastic strip.

In a further alternative provision is made for the reinforcement to be arranged on the outer surface of the hose, in particular on the outer surface of the hose wall. In this variant the armouring is therefore not completely enclosed by the plastic strip forming the hose wall, but rather is applied externally onto the hose wall. This has the advantage that the armouring can also be applied subsequently onto a hose that has already been welded up.

In accordance with a further configuration of the invention provision is made for the fibre reinforcement to comprise threads that are laid over one another and/or woven in a crosswise manner. The laying of the threads over one another in a crosswise manner has the advantage of ease of manufacturability. For example, a first layer is firstly generated from a plurality of threads arranged parallel to one another, and then a second layer of a plurality of threads arranged parallel to one another is laid onto the first layer, wherein the threads of the second layer are arranged so that they are angularly displaced relative to the threads of the first layer. While in comparison the weaving of the threads in a crosswise manner is somewhat more complex, it has the advantage of a more secure linkage of the threads. The threads that are woven together are also designated as warp threads and weft threads. The threads can be woven together, i.e. crossed over one another, such that each warp thread is alternately guided over and under a weft thread, and vice versa.

The mechanical properties of the hose can be improved in accordance with a further form of the invention by means of a thread reinforcement, which comprises at least one axially running thread. The thread reinforcement can take the form of at least one thread or at least one yarn, which runs in the axial direction, that is to say parallel to the central axis of the hose, and thus reinforces the tensile stiffness of the hose in the longitudinal direction. The axial thread reinforcement can be integrated into the plastic strip and thus also into the hose wall, and can be completely enclosed by the material of the latter. Alternatively or additionally the axial thread reinforcement can be arranged between the hose wall and the inner layer. Furthermore the axial thread reinforcement can be continuously implemented over the whole length of the hose. This can signify that the axial thread reinforcement exits from one winding of the plastic strip in the region of the overlaps, and re-enters directly into the adjacent winding of the plastic strip. This arrangement of the axial thread reinforcement can be achieved by laying, or inserting, the thread reinforcement into the material of the plastic strip immediately after the extrusion, winding and welding/adhesive bonding of the plastic strip, which at this point in time is still viscous. After the cooling and hardening of the plastic strip the axial thread reinforcement can thus be surrounded by the material of the plastic strip, i.e. of the hose wall. A hose preferably has a plurality of axial thread reinforcements, which can, for example, be distributed at equal spacings over the periphery of the hose, and thus run parallel to one another and also parallel to the central axis.

Finally, in accordance with a further configuration of the invention, it is proposed that the fabric reinforcement and/or the thread reinforcement be manufactured from a polyamide or a polyester yarn. These materials are distinguished by a particularly high tensile strength with high flexibility. In particular, provision can be made for the fabric reinforcement and/or the thread reinforcement to have electrically conducting threads, in particular copper threads, aluminium threads, or carbon threads. In this manner the improvement of mechanical properties by means of the reinforcements (e.g. stiffness, strength) can be combined with the improvement of electrical properties (e.g. conductivity) of the hose.

### BRIEF DESCRIPTION OF THE DRAWINGS

In what follows the invention is explained in further detail with the aid of a drawing representing just one preferred example of embodiment. In the figures:

FIG. 1a shows a first configuration of a plastic strip for the manufacture of an inventive plastic hose,

FIG. 1b shows a second configuration of a plastic strip for the manufacture of an inventive plastic hose,

FIG. 2a shows a fabric of threads laid over one another in a crosswise manner for purposes of reinforcing an inventive plastic hose,

FIG. 2b shows a fabric of threads woven in a crosswise manner for purposes of reinforcing an inventive plastic hose,

FIG. 3a shows a first configuration of an inventive hose in a longitudinal section,

FIG. 3b shows the hose shown in FIG. 3a with an axial thread reinforcement,

FIG. 4a shows a second configuration of an inventive hose in a longitudinal section,

FIG. 4b shows the hose shown in FIG. 4a with an axial thread reinforcement,

FIG. 5a shows a third configuration of an inventive hose in a longitudinal section,

FIG. 5b shows the hose shown in FIG. 5a with an axial thread reinforcement,

FIG. 6a shows a fourth configuration of an inventive hose in a longitudinal section,

FIG. 6b shows the hose shown in FIG. 6a with an axial thread reinforcement.

### DETAILED DESCRIPTION OF THE INVENTION

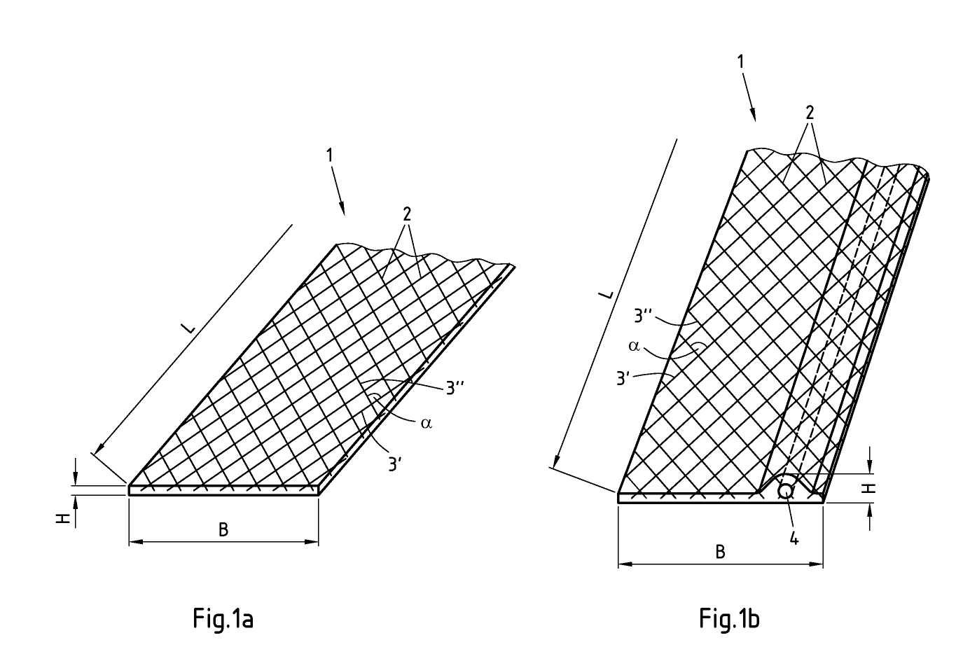

FIG. 1a represents a first configuration of a plastic strip 1 for the manufacture of an inventive plastic hose, The cross-section of the plastic hose 1 has a height H, a width B, and a length L, wherein the width B is significantly larger than, in particular at least 10, 20 or 80 times as large as, the height H of the plastic strip 1. For example, the height H can lie in the range between 0.1 mm and 5 mm, while the width B can lie in the range between 10 mm and 80 mm. The length L is a multiple of the height H and the width B; it can amount to several hundred metres or more. The plastic strip 1 represented in an exemplary manner in FIG. la is typically manufactured by means of an extrusion method, wherein a plastic mass becomes viscous under the influence of heat and/or pressure and is then pressed through a shaping nozzle, the opening of which corresponds to the cross-sectional area of the plastic strip 1. In this manner plastic strips 1 can be manufactured with a constant cross-sectional area and with any length.

The plastic strip 1 represented in FIG. 1a has a fabric reinforcement 2. The fabric reinforcement 2 features a plurality of threads 3, which are woven together in a crosswise manner. The threads 3 take the form of warp threads 3′ and weft threads 3″, which subtend an angle α. The angle α can lie in the range between 60° and 80°. In an alternative to the variant represented in FIG. 1a a fabric reinforcement 2 can also be achieved, in that the threads 3′, 3″ are not woven together, but are simply laid over one another in a crosswise manner. In the plastic strip 1 represented in an exemplary manner in FIG. 1a the fabric reinforcement 2 is integrated into the plastic strip 1 and is completely surrounded by the material of the latter.

FIG. 1b shows a second configuration of a plastic strip 1 for the manufacture of an inventive plastic hose. Those regions of the plastic strip 1 that have already been described in connection with FIG. 1a, are provided in FIG. 1b—and in all other figures—with corresponding reference symbols. The essential difference from the plastic strip 1 represented in FIG. 1a, lies in the fact that the plastic strip 1 represented in FIG. 1b in addition to the fabric reinforcement 2 also has armouring 4. The armouring 4 is also integrated into the plastic strip 1 and fully surrounded by the material of the latter. The outer surface of the plastic strip 1 is curved outwards in the region of the armouring 4, so that the plastic strip 1, in comparison to the non-armoured plastic strip 1 represented in FIG. 1a, has a greater maximum height H. The armouring 4 can be manufactured from a plastic or a metal, and has a higher stiffness than the material of the plastic strip 1.

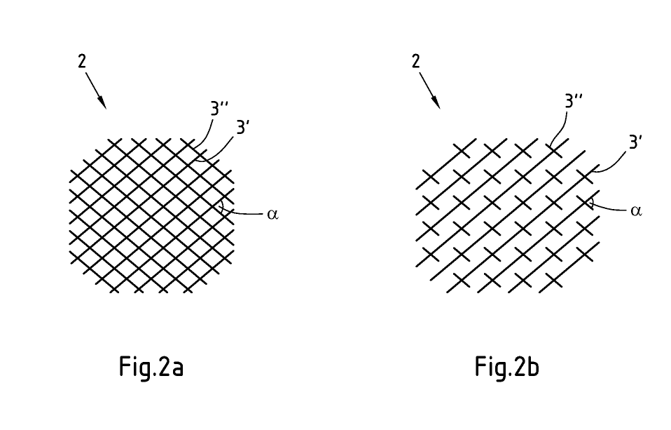

FIG. 2a represents a fabric of threads 3 laid over one another in a crosswise manner for purposes of reinforcing an inventive plastic hose. The threads 3 take the form of warp threads 3′ and weft threads 3″, which subtend an angle α. The warp threads 3′ are loosely laid over the weft threads 3″ and are not woven or interlaced with the latter. In contrast FIG. 2b shows a fabric of threads 3 woven in a crosswise manner for purposes of reinforcing an inventive plastic hose. This fabric once again features warp threads 3′ and weft threads 3″, which subtend an angle α. However, unlike FIG. 2a the various threads 3′, 3″ in the fabric shown in FIG. 2b are woven or interlaced with one another.

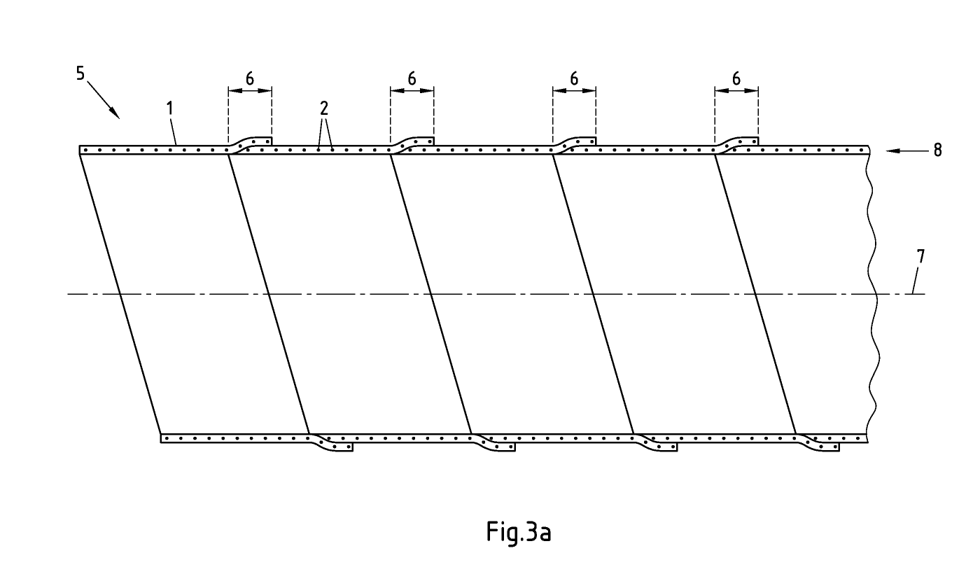

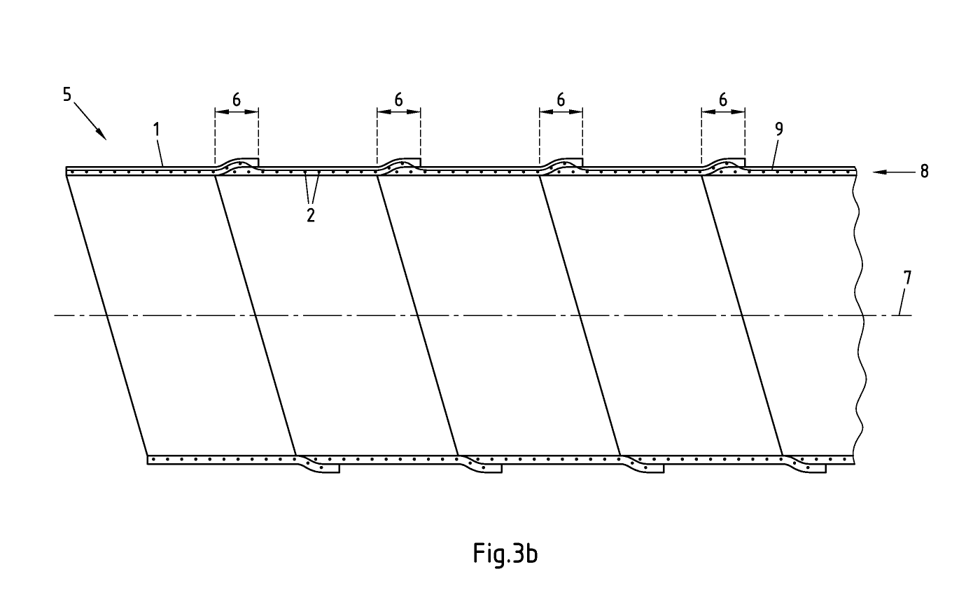

FIG. 3a shows a first configuration of an inventive hose 5 in a longitudinal section. The hose 5 is manufactured from the above-described plastic strip 1. In this form of manufacture the plastic strip 1 is wound in a spiral form, wherein the edge regions of the plastic strip 1 form an overlap 6. The overlapping edge regions of the plastic strip 1 are subsequently welded or adhesively bonded with one another such that a reliable sealing of the seam is achieved. The hose 5 manufactured in this manner runs symmetrically about a central axis 7 extending in the longitudinal direction of the hose 5, wherein the welded or adhesively bonded plastic strip 1 forms a hose wall 8. The hose 5 shown in FIG. 3a has a fabric reinforcement 2, which can, for example, take the form of one of the above-described fabric reinforcements 2 made of threads 3, 3′, 3″ laid over one another or woven. The fabric reinforcement 2 is integrated into the plastic strip 1 and thus also into the hose wall 8, and is completely enclosed by the material of the latter.

In FIG. 3b the hose 5 shown in FIG. 3a is represented with an axial thread reinforcement 9. Those regions of the hose 5 that have already been described in connection with FIG. 3a, are provided in FIG. 3b—and in all other figures—with corresponding reference symbols. The essential difference from the hose 5 shown in FIG. 3a lies in the axial thread reinforcement 9. This thread reinforcement 9 can take the form of at least one thread or at least one yarn, which runs in the axial direction, that is to say parallel to the central axis 7, and thus reinforces the tensile stiffness of the hose 5 in this direction. The axial thread reinforcement 9 is integrated into the plastic strip 1 and thus also into the hose wall 8, and is completely enclosed by the material of the latter. Furthermore the axial thread reinforcement 9 is continuously implemented over the whole length of the hose 5. This signifies that the axial thread reinforcement 9 exits from one winding of the plastic strip 1 in the region of the overlaps 6, and re-enters directly into the adjacent winding of the plastic strip 1. This arrangement of the axial thread reinforcement 9 is achieved by laying, or inserting, the thread reinforcement 9 into the material of the plastic strip 1 a very short time after the extrusion, winding and welding/adhesive bonding of the plastic strip 1, which at this point in time is still viscous. In particular the axial thread reinforcement 9 can be inserted into the viscous material of the plastic strip 1 up to the depth of the fabric reinforcement 2 that is already present in the plastic strip 1. After the cooling and hardening of the plastic strip 1 the axial thread reinforcement 9 is thus surrounded by the material of the plastic strip 1, i.e. of the hose wall 8. The hose 5 preferably has a plurality of axial thread reinforcements 9, which can, for example, be distributed at equal spacings over the periphery of the hose 5, and thus run parallel to one another and also parallel to the central axis 7.

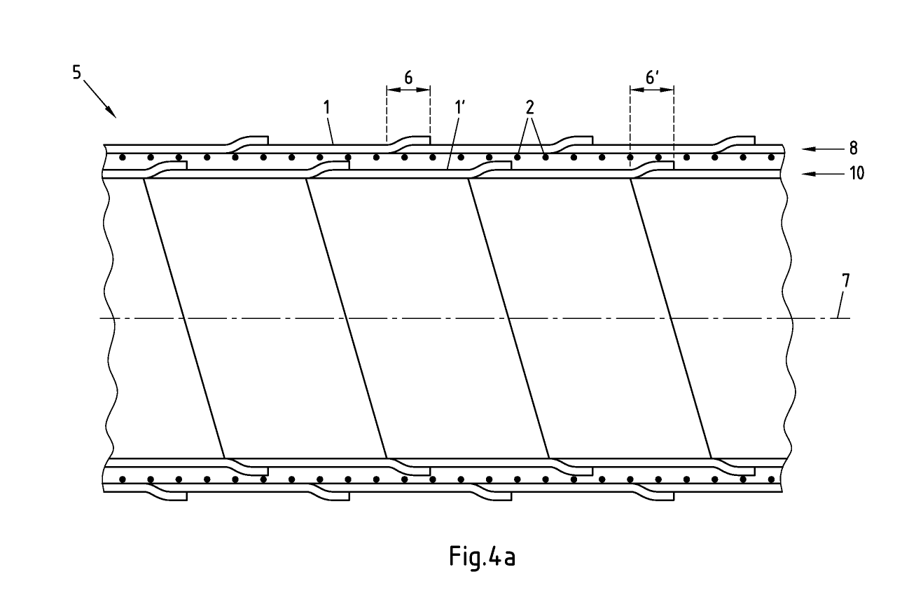

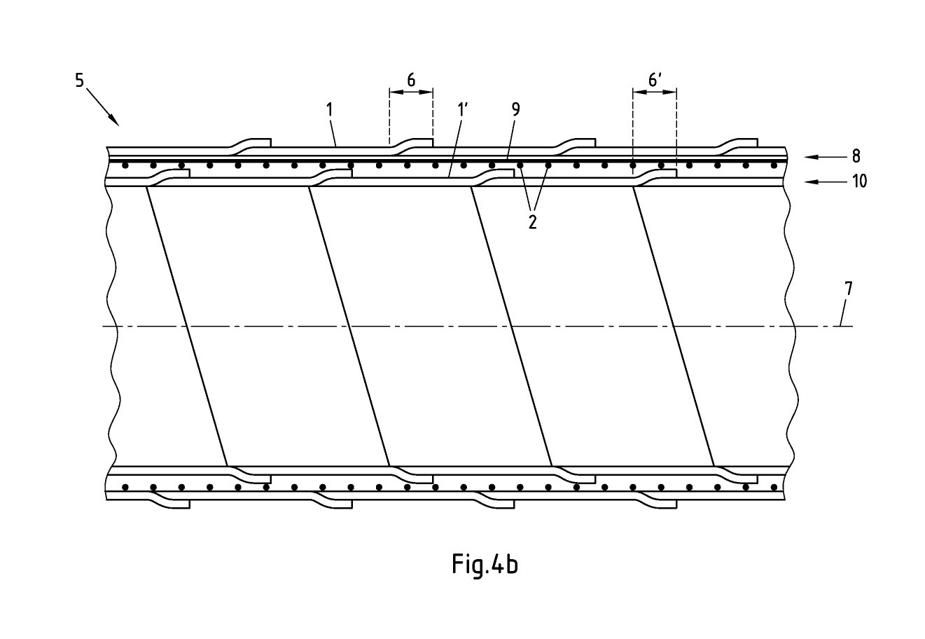

FIG. 4a shows a second configuration of an inventive hose 5 in a longitudinal section. In particular the hose 5 shown in an exemplary manner in FIG. 4a differs from the first configuration (FIG. 3a) in that in addition to the hose wall 8 an inner layer 10 is also present. The hose wall 8 is formed by the plastic strip 1, which is welded or adhesively bonded in the region of its overlaps 6. In a corresponding manner the inner layer 10 is formed by means of a second plastic strip 1′, which is welded or adhesively bonded in the region of its overlaps 6′. In this configuration of the hose 5 the fabric reinforcement 2 can be arranged between the hose wall 8 and the inner layer 10 so that the fabric reinforcement 2 does not need to be integrated into the plastic strip 1, 1′, i.e. into the hose wall 8 or into the inner layer 10.

In FIG. 4b the hose 5 shown in FIG. 4a is represented with an axial thread reinforcement 9. Here too those regions of the hose 5 that have already been described in connection with FIG. 4a, are provided with corresponding reference symbols. The essential difference from the hose 5 shown in FIG. 4a lies in the axial thread reinforcement 9, which can take the form of at least one thread or at least one yarn, which runs in the axial direction, that is to say parallel to the central axis 7. The axial thread reinforcement 9 is continuously implemented over the whole length of the hose 5, and can thus reinforce the tensile stiffness of the hose 5 in this direction. Unlike FIG. 3b, however, the axial thread reinforcement 9 is not necessarily integrated into one of the plastic strips 1, 1′ and thus into the hose wall 8 or into the inner layer 10. Instead the axial thread reinforcement 9—in the same way as the fabric reinforcement 2—can be arranged between the hose wall 8 and the inner layer 10. This arrangement of the axial thread reinforcement 9 is achieved by laying the thread reinforcement 9—in the same way as the fabric reinforcement 2—onto the inner layer 10 after the manufacture of the inner layer 10. The plastic strip 1 is then spirally wound around the inner layer 10 and the two reinforcements 2, 9 and welded or adhesively bonded in the region of the overlap 6.

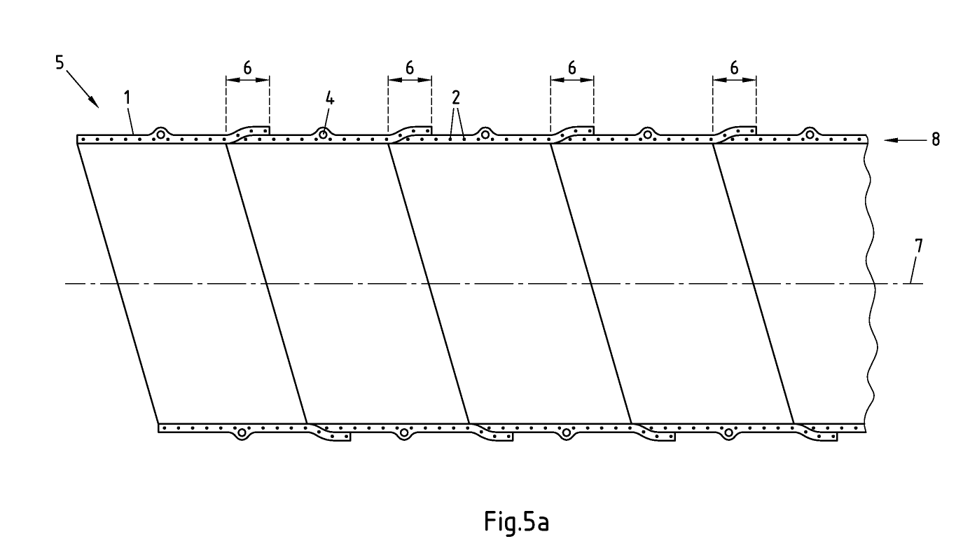

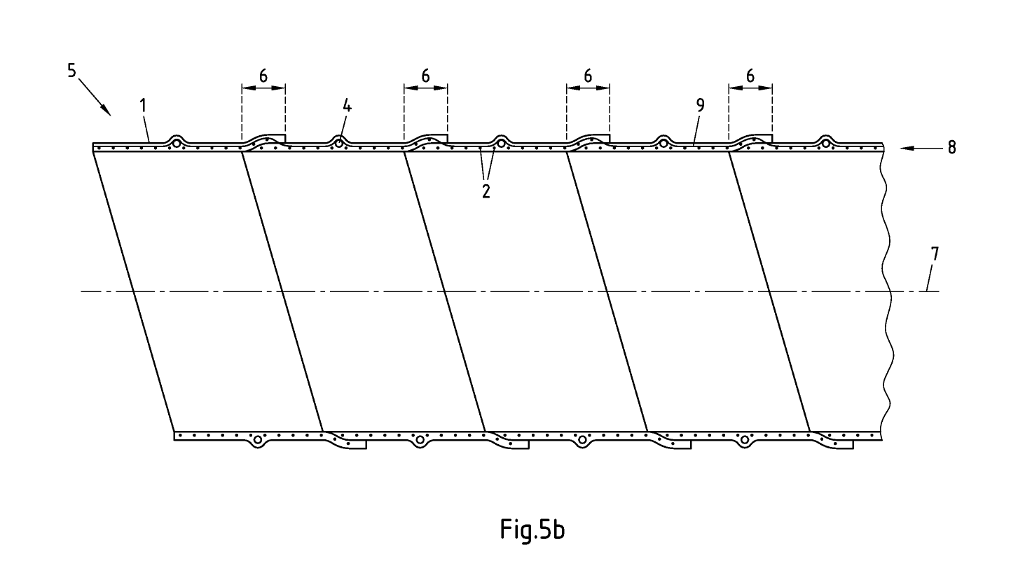

FIG. 5a shows a third configuration of an inventive hose 5 in a longitudinal section. Furthermore the hose 5 shown in FIG. 5a is represented in FIG. 5b with an axial thread reinforcement 9. The third configuration of FIGS. 5a and 5b corresponds to a large extent to the first configuration of FIGS. 3a and 3b. The essential difference consists in the fact that for the manufacture of the hose 5 in accordance with the first configuration (FIGS. 3a, 3b) a plastic strip 1 without armouring 4 has been used (cf. FIG. la), while for the manufacture of the hose 5 in accordance with the third configuration (FIGS. 5a, 5b) a plastic hose 1 with armouring 4 has been used (cf. FIG. lb). In the hose 5 shown in FIG. 5b the axial thread reinforcement 9 is arranged outside the armouring 4. Nevertheless both the armouring 4 and also the axial thread reinforcement 9 are integrated into the hose wall 8, and are completely enclosed by the material of the latter.

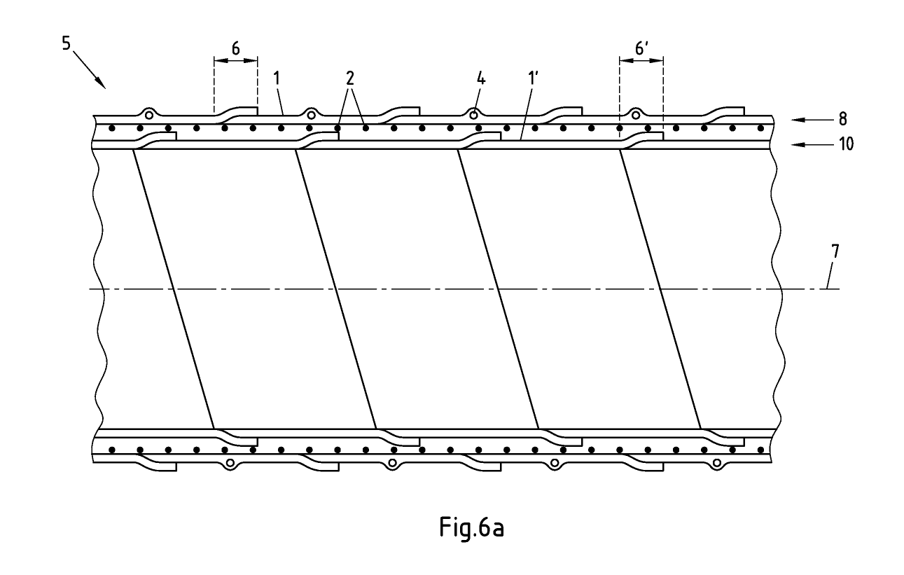

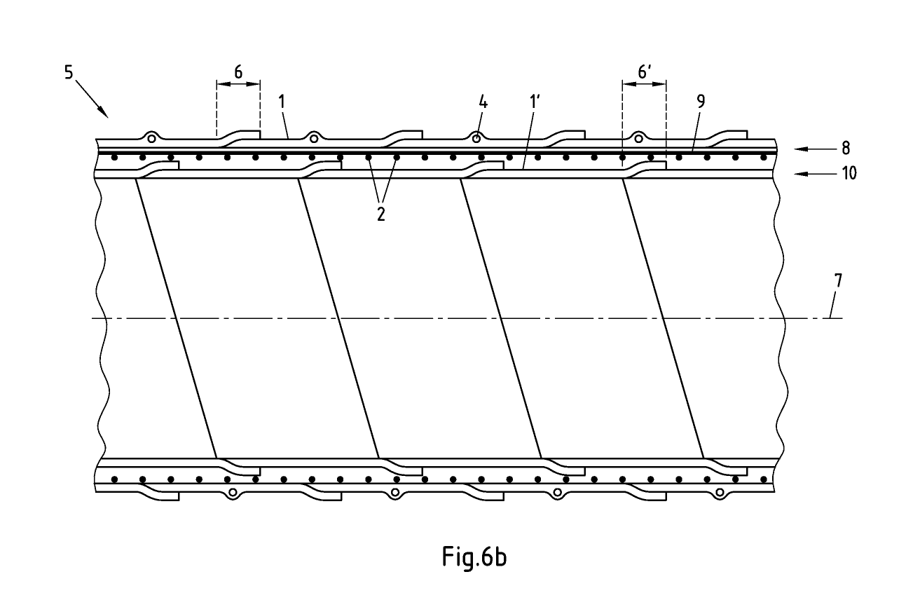

FIG. 6a shows a fourth configuration of an inventive hose 5 in a longitudinal section. Furthermore the hose 5 shown in FIG. 6a is represented in FIG. 6b with an axial thread reinforcement 9. The fourth configuration of FIGS. 6a and 6b corresponds to a large extent to the second configuration of FIGS. 4a and 4b. The essential difference consists in the fact that for the manufacture of the hose wall 8 of the hose 5 in accordance with the second configuration (FIGS. 4a, 4b) a plastic strip 1 without armouring 4 has been used (cf. FIG. 1a), while for the manufacture of the hose wall 8 of the hose 5 in accordance with the fourth configuration (FIGS. 6a, 6b) a plastic hose 1 with armouring 4 has been used (cf. FIG. 1b). In the hose 5 shown in FIG. 6b the axial thread reinforcement 9 is arranged outside the armouring 4. Nevertheless both the armouring 4 and also the axial thread reinforcement 9 are arranged between the hose wall 8 and the inner layer 10.

### LIST OF REFERENCE SYMBOLS

1, 1′: Plastic strip
2: Fabric reinforcement
3: Threads
3′: Warp threads
3″: Weft threads
4: Armouring
5: Hose
6, 6′: Overlap
7: Central axis
8: Hose wall
9: Thread reinforcement
10: Inner layer
α: Angle
H: Height
B: Width
L: Length

1. A plastic hose, comprising:
a hose wall of plastic, and
a fabric reinforcement,
wherein
the hose wall is manufactured from one or a plurality of spirally-wound plastic strips.

2. The plastic hose in accordance with claim 1, wherein
the fabric reinforcement is integrated into the hose wall.

3. The plastic hose in accordance with claim 1, wherein
an inner layer extends over the whole of the inner surface of the hose.

4. The plastic hose in accordance with claim 3, wherein
the inner layer is manufactured from one or a plurality of spirally-wound plastic strips.

5. The plastic hose in accordance with one claim 1, wherein
the plastic strip forming the hose wall and/or the inner layer has edge regions arranged in an overlapping manner; in the region of the overlap these edge regions are materially bonded with one another.

6. The plastic hose in accordance with claim 3, wherein
the thickness of the inner layer is less than the thickness of the hose wall.

7. The plastic hose in accordance with claim 3, wherein
the fabric reinforcement is arranged between the hose wall and the inner layer.

8. The plastic hose in accordance with claim 1, further comprising
an armouring of plastic or metal, wherein the armouring has a higher stiffness than the hose wall and/or the inner layer.

9. The plastic hose in accordance with claim 8, wherein
the armouring is designed in the form of a spiral.

10. The plastic hose in accordance with claim 8, wherein
the armouring is arranged between the overlapping edge regions of the plastic strip.

11. The plastic hose in accordance with claim 8, wherein
the armouring is integrated into the plastic strip.

12. The plastic hose in accordance with claim 8, wherein
the armouring is arranged on the outer surface of the hose.

13. The plastic hose in accordance with claim 1, wherein
the fabric reinforcement comprises threads laid over one another in a crosswise manner, and/or threads woven in a crosswise manner.

14. The plastic hose in accordance with claim 1, further comprising
a thread reinforcement, which comprises at least one axially running thread.

15. The plastic hose in accordance with claim 14, wherein
the fabric reinforcement and/or the thread reinforcement is manufactured from a polyamide or a polyester yarn.

16. The plastic hose in accordance with claim 2, wherein
an inner layer extends over the whole of the inner surface of the hose.

17. The plastic hose in accordance with claim 1, wherein the plastic strip forming the hose wall and/or the inner layer has edge regions arranged in an overlapping manner; in the region of the overlap these edge regions are materially bonded with one another.

18. The plastic hose in accordance with claim 2, wherein the plastic strip forming the hose wall and/or the inner layer has edge regions arranged in an overlapping manner; in the region of the overlap these edge regions are materially bonded with one another.

19. The plastic hose in accordance with claim 3, wherein the plastic strip forming the hose wall and/or the inner layer has edge regions arranged in an overlapping manner; in the region of the overlap these edge regions are materially bonded with one another.

20. The plastic hose in accordance with claim 4, wherein the fabric reinforcement is arranged between the hose wall and the inner layer.
